(19) United States
(12) Patent Application Publication
(10) Pub. No.: US 2015/0012977 A1
(43) Pub. Date: Jan. 8, 2015

(54) METHOD AND APPARATUS FOR SECURITY IN CLOUD COMPUTING SERVICE

(71) Applicant: INTELLECTUAL DISCOVERY CO., LTD., Seoul (KR)

(72) Inventors: Eui Nam Huh, Seoul (KR); Sang Ho Na, Yongin-si (KR); Jun Young Park, Yongin-si (KR); Jin Taek Kim, Seoul (KR)

(73) Assignee: INTELLECTUAL DISCOVERY CO., LTD., Seoul (KR)

(21) Appl. No.: 14/345,177

(22) PCT Filed: Dec. 5, 2012
(86) PCT No.: PCT/KR2012/010487

§ 371 Date: Mar. 14, 2014

(30) Foreign Application Priority Data
Dec. 5, 2011 (KR) 10-2011-0129242

(51) Int. Cl. G06F 21/30; G06F 21/31; H04L 29/06

(52) U.S. Cl. CPC G06F 21/30; H04L 63/10; G06F 21/31; H04L 63/0876
USPC 726/4

(57) ABSTRACT

Provided is a method and apparatus for security in a cloud computing service. A service integration unit provides various cloud services to a terminal over a personal virtual network. An authentication unit performs authentication on a user of the terminal through redirection in the service integration unit. The service integration unit generates a virtual machine for providing a cloud service requested by the terminal on a service providing unit. The service providing unit provides the cloud service to the terminal authenticated by the user.

### TECHNICAL FIELD

The following embodiments relate to security in a cloud computing service, and more particularly, to a security method, apparatus, and system for providing a personal cloud service through a cloud computing security element.

### BACKGROUND ART

Cloud computing refers to technology of providing a large scale of information technology (IT) resources using virtualization technology and distributed processing technology. Using a cloud computing service, a user may be provided with a service with respect to computing resources through the Internet. Computing resources may include a memory resource, a central processing unit (CPU) resource, a network resource, a storage resource, and the like. The user may pay an entity operating the cloud computing service a fee corresponding to an amount of computing resources used by the user.

Specifically, cloud computing refers to technology of integrating, into a single computing resource through virtualization technology, computing resources that are present at physically different positions, and providing the integrated computing resource to users. For example, cloud computing may be regarded as an “Internet based and user centered on-demand outsourcing service technology”.

When the Internet is provided, the user may use a computing environment of the user through the cloud computing service without restrictions on a time and an occasion. The cloud computing service charges the user with a fee corresponding to an amount of resources used by the user. Also, through a computing environment of the cloud computing service, the user may be provided with all of the services such as a hardware service, a software service, an after service (AS), and the like. Accordingly, costs for maintaining and repairing a system may be reduced, costs for purchasing software may be reduced, and an amount of energy used for computing processing may be reduced.

With the increasing attention to the cloud computing service, the cloud computing service has been widely distributed under the lead of major IT companies. The cloud computing service includes four cloud computing service types, such as a public cloud service, a private cloud service, and the like.

The public cloud service may provide a cloud service to many and unspecified users through the Internet. The public cloud service indicates neither providing of a free service nor opening of data and a source associated with a service. The public cloud service may also provide a service using a user access control, charge, and the like. In the public cloud service, a service provider may manage user information and the resources of the cloud computing service may be shared. Accordingly, the public cloud service may have a weakness in protecting personal information of a user.

The private cloud service may provide the same computing environment as in the public cloud service. The private cloud service indicates a cloud service that enables a predetermined company or institution to directly manage a cloud computing service, data, and process. Specifically, the private cloud service may be a closed cloud service type that avoids an external access and allows access of only authorized users for security.

A communication cloud service refers to a cloud computing service for a group of predetermined users. The communication cloud service may grant an access right only to members of a predetermined group. Members of a group may share data, an application, and the like through the communication cloud service.

A hybrid cloud service refers to a service in which the public cloud service and the private cloud service are combined. The hybrid cloud service may basically provide the public cloud service and may follow a policy of the private cloud service with respect to data and a service that a user does not desire to share.

A structure of the cloud computing service may be classified into an infra-type service structure, a platform-type service structure, and a software service structure. The infra-type service structure may provide a user-tailored computing environment based on requirements of a user. The platform-type service structure may provide an environment in which a user may select and use a platform suitable for a computing purpose of the user. The software service structure may provide an environment in which a user may select and use software suitable for a usage purpose.

For the cloud computing service, a robust and systematic access control and right granting policy is required. The personal cloud service may provide a cloud service through cooperation between different service providers. Accordingly, a systematic security system or security infrastructure suitable for a characteristic of the personal cloud service is required.

A model of the cloud computing service may assume that the number of cloud service providers is a single. However, a new on-demand cloud service in which various cloud services are combined through cooperation between various providers may be expected to come to the front.

In general, the Internet has a host-client structure. That is, when a terminal of a user accesses a server through the Internet, the terminal may be provided with a service from the server through the Internet. In the above structure, a security boundary that is separated into a reliable portion and an unreliable portion may be present. An area that may be managed and controlled directly by a user, such as a computer, storage, and a firewall which are present in a user local, is a reliable portion. An area that may not be viewed and controlled directly by the user, such as a network, a server, and web storage, is an unreliable portion.

In a cloud computing environment in which outsourcing is performed, a security boundary between cloud computing configuration elements for providing a cloud service may become unclear. The cloud computing configuration elements may include a terminal and a cloud service provider. In particular, to provide a cloud service based on cooperation between a plurality of cloud service providers, information of a user of the cloud service may need to be transferred and be processed between service providers.

In a user centered on-demand outsourcing computing service, protection of user information with respect to a user authentication, billing, and a service propensity of a user is required. That is, a new security service and system only for the user centered on-demand outsourcing computing service considering a cloud computing service environment based on the cooperation is required.

Considering an aspect that various services for providing cloud computing for a company and providing personalized personal cloud computing are prepared, a cloud security system and method capable of safely transferring information of a user between cloud services is required. Information of a user may include personal information and service related information. That is, with the development in cloud computing, solutions for various issues such as reliability of cloud computing, security thereof, legal contents, protection of personal information, and standardization, are required.

### DISCLOSURE OF INVENTION

### Technical Goals

An embodiment may provide a robust and systematic security system and security method for providing a cloud computing environment.

An embodiment may provide a security system and security method that considers a virtual machine for providing a virtualization environment, sharing of virtual resources, and a virtual network.

An embodiment may provide a security system and security method suitable for a cloud environment that considers features of cloud computing, that is, virtualization, distributed computing, and a cooperative service model.

### Technical Solutions

According to an aspect, there is provided a cloud service method, including receiving a request for accessing a cloud service from a terminal of a user; requesting a service providing unit providing the cloud service to verify an access right of the user to the cloud service; receiving a result of verification from the service providing unit; and granting a token of the user with the access right to the cloud service when the result of verification indicates that the user has the access right to the cloud service.

The cloud service method may further include transmitting an identifier of the terminal to an authentication unit; and receiving, from the authentication unit, a result of authenticating the user based on the identifier.

The cloud service method may further include transmitting a token of the user to the terminal.

The cloud service method may further include receiving, from the service providing unit, a request for registration information of the service cloud and right information of the user; and transmitting the registration information and the right information to the service providing unit.

The cloud service method may further include generating a configuration for providing the cloud service on the service providing unit.

The configuration for providing the cloud service may be a virtual machine that is performed on the service providing unit.

The cloud service may be provided to the terminal by the service providing unit over a virtual network.

The cloud service may be configured to be plural.

The access right may be granted to the token based on a policy of the service providing unit with respect to the cloud service.

According to another aspect, there is provided a cloud service integration server, including an access control unit to receive a request for accessing a cloud service from a terminal of a user, to request a service providing unit providing the cloud service to verify an access right of the user to the cloud service, to receive a result of verification from the service providing unit, and to grant a token of the user with the access right to the cloud service when the result of verification indicates that the user has the access right to the cloud service; and a service configuring unit to generate a configuration for providing the cloud service on the service providing unit.

The access control unit may transmit an identifier of the terminal to an authentication unit, and may receive, from the authentication unit, a result of authenticating the user based on the identifier.

The access control unit may transmit a token of the user to the terminal.

The access control unit may receive, from the service providing unit, a request for registration information of the service cloud and right information of the user, and may transmit the registration information and the right information to the service providing unit.

### Effect of the Invention

According to embodiments, there is provided a security system and security method that employs an access control method, a right delegation, and a right authorization policy suitable for a characteristic of a personal cloud service.

### BRIEF DESCRIPTION OF DRAWINGS

FIG. 1 illustrates 15 security domains of a cloud security alliance (CSA) cloud.

FIG. 2 illustrates a cloud service model.

FIG. 3 is a diagram to describe security threats against a cloud service.

FIG. 4 is a block diagram illustrating a cloud computing service system according to an embodiment.

FIG. 5 is a block diagram illustrating a configuration of a service integration unit according to an embodiment.

FIG. 6 is a flowchart illustrating a cloud service method according to an embodiment.

FIG. 7 is a block diagram illustrating a cloud computing service system according to an embodiment.

FIG. 8 is a diagram illustrating a procedure in which a user joins an identification service provider (ISP) as a member according to an embodiment.

FIG. 9 is a diagram illustrating a configuration of a market-based cloud service portable (MCSP) according to an embodiment.

FIG. 10 is a flowchart illustrating a personal information delegation and log-in procedure of a user according to an embodiment.

FIG. 11 is a flowchart illustrating a process of configuring a user service according to an embodiment.

FIG. 12 is a diagram illustrating a procedure of becoming a member of a MCSP and using the MCSP according to an embodiment.

### BEST MODE FOR CARRYING OUT THE INVENTION

Hereinafter, embodiments will be described in detail with reference to the accompanying drawings. Like reference numerals in the respective drawings refer to like elements throughout the present specification.

Hereinafter, terminology “Uniform Resource Locator (URL)”, and “Uniform Resource Identifier (URI)” are used as the same meaning, and may be replaced with each other and thereby be used.

In the following description, security methods of various cloud computing services combinable with embodiments will be described.

Security of Elastic Compute Cloud (EC2) of Amazon

EC2 of Amazon may be an Infrastructure as a Service (IaaS) cloud that provides a virtual machine (VM) for a service desired by a user client. Client software may be present with a virtual machine. Accordingly, Amazon may not have responsibility for a service that is executed within the virtual machine, excluding an infrastructure service.

Amazon may provide a robust security apparatus such as a one-time token apparatus. In general, companies using the security apparatus such as the one-time token apparatus may use a monitoring and managing tool. The monitoring and managing tool may provide functions such as integrated identifier (ID) management, active tracking, and remote control of an authentication system. A method of abolishing a used token may be a key issue in terms of a security.

In general, a security service may be provided only within an infrastructure owned by Amazon. Accordingly, an EC2 client may take the full responsibility for data within a virtual server and protection of a program. However, since data and software need to be encrypted within a service, modification of a security policy may be very difficult.

App Engine Security of Google

Code deployment documentation provided from Google discloses contents about a security service of an App engine. For security on a service, security related information may be described in detail within an eXtensible Markup language (XML) configuration file when a service is loaded to the App engine. A problem of the aforementioned App engine security solution may be that only an authentication service associated with a Google account service may be provided. A Google account uses a simple authentication scheme using a user name and a user password and thus, may be very vulnerable in terms of a security.

Also, a security service of the App engine may be performed based on only a service unit that is provided only from the App engine. A client access control scheme for each element selected from among service functions may have an unclear security service structure. A service may need to autonomously guarantee a security with respect to resources that are provided through an App engine service. However, contents specified with respect to security of a service resource may be absent.

Azure Security of Microsoft (MS)

A security service provided from Azure may be regarded to be relatively excellent compared to security services of other clouds. A client or a provider of a cloud service may generate, provide, and manage a service using Azure that is a Platform as a Service (PaaS). In order to generate, provide, and manage a service, Azure may provide a security mechanism based on a Secure Assertions Markup Language (SAMP). The SAMP enables a provider of a cloud service to control an access of service users.

A client or a service requestor may present a certificate authority (CA) for enabling an authentication on the client or the service requestor in the case of requesting a service access. The presented CA may have been issued by an identity provider (IP). The CA may be signed by the IP. The client or the service requestor may be authenticated through the above signature. For compatibility between CAs of different IPs, Azure may provide a CA conversion service. In order to use Azure, the client or the service requestor may preferentially experience a CA authentication process. Through the aforementioned authentication process, only an authenticated user request may be processed. In a security system of Azure, a CA verifying process may be pinpointed as a weakness. An Azure service may achieve a request function to an access control service of Azure and a CA verifying function. Accordingly, even though the security service is provided from Azure, a developer of the Azure service may need to passively decide a security policy.

Hereinafter, issues of security solutions combinable with embodiments will be described.

Resource Protection

A resource of a cloud may be provided only through a cloud service. Accordingly, a resource security may be obligatorily required and an optimal solution for the resource security may be required. When a client accesses a cloud service, a service may be executed after the resource security is guaranteed.

The resource protection may be achieved through the following methods:

1) Discretionary system: Approval or rejection with respect to a resource access right of a client may be performed by a cloud service provider. The weakest point of the discretionary system may lie in that a meaning of client authentication associated with stored data is not considered.

2) Non-discretionary system: Approval or rejection with respect to a resource access right may be performed based on classification and authentication by a client. Classification may be classification of data or an application.

Access Control Matrix (ACM)

An ACM may be one of the most widely used security access methods. The ACM uses a matrix and thus, may easily approve, abolish, and determine an access right. However, the ACM may not smoothly operate in a centralized distributed computing environment. The ACM may include a line indicating an access control list (ACL) and a column indicating capabilities. Each resource of a system may have a service list. A service list may have services and an execution right of each of the services. The ACL may be applied to all of the resources. Accordingly, process classification of the ACL may not be in detail, but right management of the ACL may be easily performed. On the contrary, a security system using capabilities may grant a right to a client or a service that is allocated to the client. In general, user capabilities may define a resource and a right about the resource. The capabilities and the ACL may have a complementary relationship in terms of strong points and weak points.

Attribute Based Access Control (ABAC)

Another security model is ABAC. The ABAC and an ACM may differ in terms of a right granting scheme through 1) attributes that are allocated to a service and a resource and 2) a policy. An attribute such as a name and a role may be allocated to the service. An owner and a domain may be allocated to the resource. A predetermined function of the service may be performed within the range of satisfying a policy rule. The range of satisfying the policy rule may be determined by comparing each attribute of the service and each attribute of the resource. The ABAC may have an issue about attribute verification based on use of an attribute.

Information Flow Control

An access right may be granted based on stored confidential data and user approval. In terms of right authorization, a model capable of extending a function and correcting an ACL may be proposed. A clearance capability may be a reliable identifier that includes an additional function for data protection. The clearance capability may include a security operation of providing a client authentication with respect to an information access of a predetermined class.

When the clearance capability is obtained, the following comparison procedure may be performed. First, contents of an approval field and classification of a requested resource may be compared. When contents of the approval field correspond to classification of the requested resource, a security state may be determined to be “secure”. Otherwise, an access requested by the client may be rejected. When the security state is “secure”, an access rights field and a requested work may be compared. When the access rights field corresponds to the requested work, the client may access the requested resource.

Hereinafter, a communication and storage security issue combinable with embodiments will be described.

Cost of Encryption

Resources within a cloud may vary from simple information storage up to a perfect business workflow. Since all of the clients need to be identified, data security in a shared environment may become complex. Also, even though encryption may be provided for protecting stored data, high cost may occur every time encrypted data is used.

Stability of Data Communication

Even though data security within a cloud is perfect, communication between a client and the cloud and communication between the cloud and a predetermined data service may need to be protected. Also, confidentialness and data integrity may need to be guaranteed while transmitting data. A Transport Layer Security (TLS), a TLS processor, a Secure Sockets Layer (SSL), and a Hypertext Transfer Protocol over SSL (HTTPS) are encryption protocols and may provide communication security of a network that is directly connected to the Internet or the cloud. An encryption system may use a Symmetric Key Cryptosystem (SKC) scheme or an Asymmetric Key Cryptosystem (AKC) scheme. The SKC scheme may have a simple structure, but may have a weak point in terms of key management. The AKC scheme may use the respectively different keys for encrypting and decrypting data by complementing the weak point of the AKC.

Asymmetric Key Cryptosystem (AKC)

An AKC may use two keys, for example, a private key and a public key. When data is asymmetrically encrypted using one of the public key and the private key, a remaining key may be used to decrypt the data. In terms of the AKC, two keys may have a one-way characteristic. The public key may be open to anybody. Accordingly, the AKC may be vulnerable to a Man In The Middle Attack (MITMA). An issue that the AKC is vulnerable to the MITMA may be solved by a Certificate Authority (CA).

Authentication

In a cloud, authentication of a service, a service provider, and a cloud client may be obligatorily required. A single-factor authentication using an ID and a password may be insufficient to provide a safe authentication. Accordingly, a double authentication may be proposed. The double authentication may be to perform a client authentication using two authentication means among proposed three authentication means. For example, three authentication means may be “something you know” such as a password, “something you have” such as a token or a smart card, and “something you are” such as a fingerprint. When a mutual authentication is required, configuring of the double authentication may be difficult. For the mutual authentication, the client may need to perform the mutual authentication with respect to a cloud service. Also, cloud services on a workflow may need to perform the mutual authentication. Depending on necessity of such authentication, a robust encryption based authentication such as an electronic signature may be required. A message may be converted to a hash value by a hash function. An electronic signature may be generated by applying a private key to the hash value. The electronic signature may be transmitted together with an original message. A receiver who receives the message may convert the original message to a first hash value. Also, the receiver may generate a second hash value by decrypting the electronic signature using a public key. The receiver may compare the first hash value and the second hash value. When the first hash value and the second hash value match as the comparison result, the receiver may verify that the original message is not altered.

Kerberos

Kerberos may authenticate a user without transmitting a user ID and a password. Kerberos may use an AKC. A ticket is a token that is robustly encrypted and electronically signed. An authentication on a service access from a remote domain may be performed through inter-Kerberos key sharing. Kerberos may provide a very robust and safe infrastructure environment. Kerberos may be provided even in a distributed computing environment. Accordingly, Kerberos may be applied even in a cloud environment.

Cloud Computing Security Architecture

As described above, a cloud service provided to a client may connote various security issues. A cloud security white paper of a Cloud Security Alliance (CSA) may be applied with respect to security threats, domains, and security control schemes in a cloud.

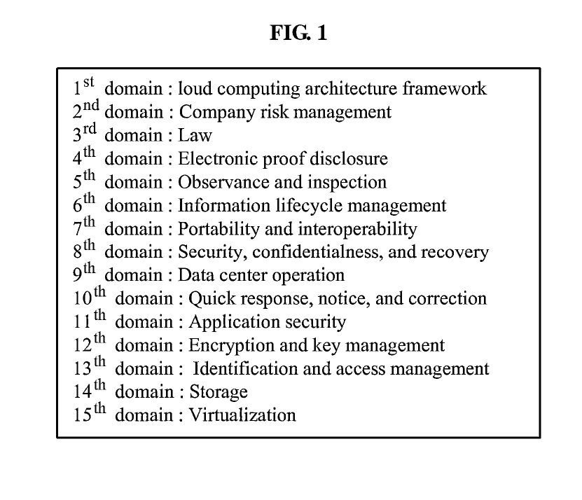

Hereinafter, a cloud service model will be described with reference to FIGS. 1 through 3. Three cloud service models may be present. 15 security domains and seven top threats may be present in association with three cloud service models. Also, a security structure of cloud computing including ten security control models and related standard technologies may be provided in order to solve the threats.

FIG. 1 illustrates 15 security domains of a CSA cloud.

FIG. 1 illustrates names of 15 domains from a first domain to a fifteenth domain.

The range of cloud security is relatively wide, whereas a standard is not clearly defined and thus, a cloud security field may be immature. Accordingly, reviews on understanding of business risks and advantages of a cloud need to be conducted. For example, a predetermined database service may not support a flexible authentication and a detail security.

In terms of a security domain, the following issues may be considered.

Security Controls

Security controls may define a security control scheme that is required in association with security threats and domains, and may explain security requirements.

Asset Management

Asset management may need to manage all of hardware, network, and software assets that constitute a cloud infrastructure. The software asset may be a physical software asset or a virtual software asset. In terms of asset management, an account capable of accessing a physical base or a network base of an asset may be included in order to observe an inspection and a regulation.

Cryptography: Key and Certificate Management

A security system may require an infrastructure for managing a cryptographic key and CA. Also, the security system may include a standard-based encryption function and a service for information protection.

Data/Storage Security

In terms of data security, data may be encrypted and thereby be stored. Also, a few cloud service users may desire to store data in an individual space different from other users in order to protect their own data.

Endpoint Security

Users may need to provide endpoint security in a cloud service. Limited endpoint security may be provided based on a network protocol and a device type.

Event Auditing and Reporting

A user may access data with respect to an event that occurs in a cloud, in particular, a system error and security.

Identity, Roles, Access control, and Attributes

To achieve an effective access control with respect to a cloud-based resource and to enforce a security policy, identity, roles, authorization, and attributes may need to be defined. The authorization may correspond to delegation. The attributes may be determined based on a user and a service.

Network Security

Protection with respect to network traffic of a packet end, a router, and a switch may be required. Also, security with respect to an IP stack may be required.

Security Policies

In terms of security policies, polices with respect to access control, resource allocation, consistent determination, and the like, may need to be defined and be determined. Also, execution of the security policies may be required. Policies may be automatically defined in accordance with a Service Level Alliance (SLA) and a license.

Service Automation

A security control flow of security auditing may be automated. Also, management and analysis of a process may be automated. In service automation, when a violation of a user against a security policy or a license occurs, the violation may be notified to a manager through an event.

Workload and Service Management

An environment setting, operation, and surveillance service may be provided in accordance with a defined security policy and user license agreement.

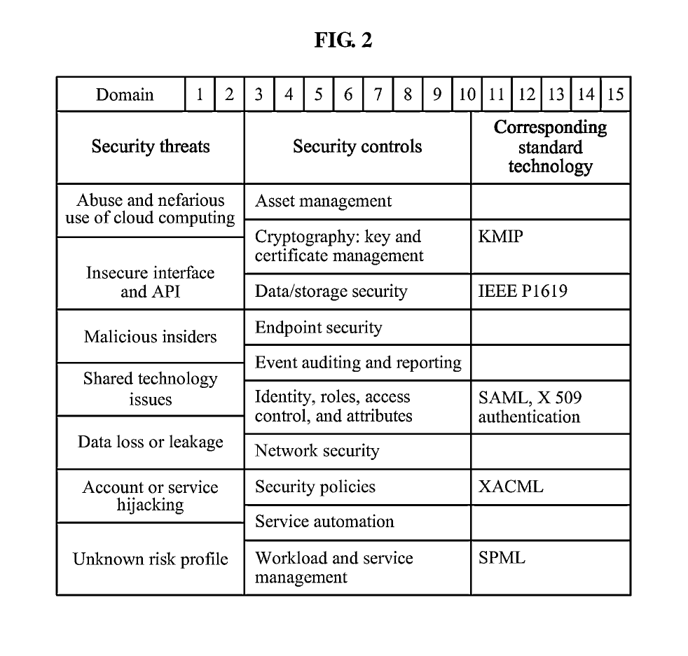

FIG. 2 illustrates a cloud service model.

In FIG. 2, numbers of an upper end denote 15 security domains described above with reference to FIG. 1.

Items listed below “security threats” on the left side of FIG. 2 denote seven threats that are defined based on weak points that are present in cloud computing. Items listed below “security controls” denote security controls corresponding to the respective security threats. Items listed below “corresponding standard technology” on the right side of FIG. 2 denote a standard technology corresponding to a security control.

At least one of a Software as a Service (SaaS), a Platform as a Service (PaaS), and an Infrastructure as a Service (IaaS) may be applied to each of the security controls.

The following items may be included as top threats of cloud computing.

A first threat may be “abuse and nefarious use of cloud computing”. In a case in which a cloud is introduced for a malicious intent, a potentially great threat may be regarded to be present compared to an existing bot-net due to a characteristic of the cloud that information is present within a virtual space.

A second threat may be “insecure interface and application programming interface (API)”. In a case in which an application is constructed through reuse and synthesis of an existing code in order to provide an added value, security vulnerability may occur due to an increase in complexity.

A third threat may be “malicious insiders”. A guideline or a standard may be absent in employing an employee for a cloud service. A probability of hiring a person with a malicious intent, such as a hacker, an organized crime, and an industrial spy, may increase and thus, data within the cloud service may be leaked.

A fourth threat may be “shared technology issues”. An IaaS may provide expendability based on a shared technology. The fourth threat may be present in a case in which effective resource separation for a multi-tenant architecture is not performed.

A fifth threat may be “data loss or leakage”. Due to a structural/operative characteristic of a cloud environment, a data leakage risk may increase. Various reasons of the fifth threat may exist.

A sixth threat may be “account or service hijacking”. In a cloud service, an account access using phishing, fraud, and software vulnerability may be regarded as a general circumstance. Leakage of account information in a cloud environment may be a threat equivalent to exposure of “everything you have or are”.

A seventh threat may be “unknown risk profile”. A software version, code update, a vulnerability profile, intrusion attempt, a security design, and the like, may be regarded as essential elements for inspecting a current security state of a company.

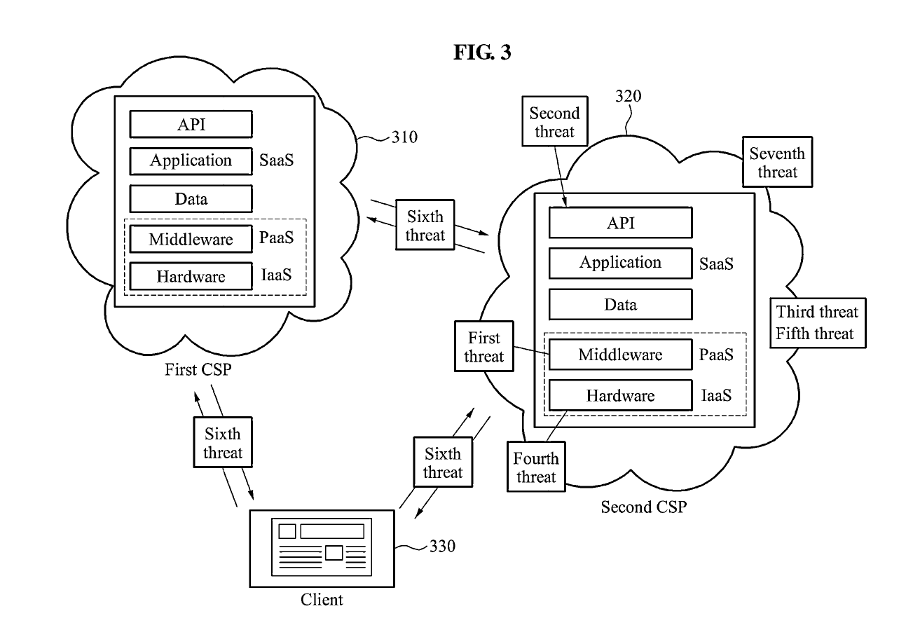

FIG. 3 is a diagram to describe security threats against a cloud service.

Each of first through seventh threats of FIG. 3 may correspond to one of the first through seventh threats described with reference to FIG. 2.

Entities, such as hardware, middleware, data, an application, and an application programming interface (API), may be present within a first cloud service provider (CSP) 310 and a second CSP 320. Hardware may correspond to an IaaS. Middleware may correspond to a PaaS. Data, the application, and the API may correspond to a SaaS.

An arrow indicator from a threat to an entity may indicate a threat that may be applied to a predetermined entity. For example, the second threat may be applied to, particularly, the API, and the sixth threat may be applied to a client 330.

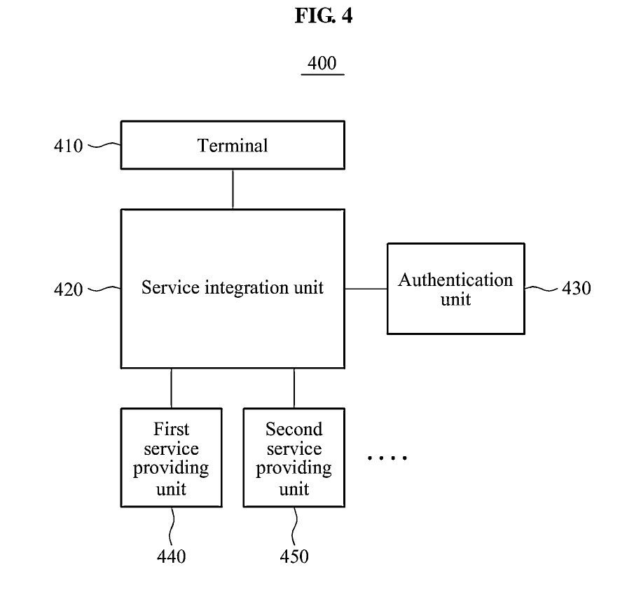

FIG. 4 is a block diagram illustrating a cloud computing service system according to an embodiment.

A cloud computing service system 400 may include a terminal 410, a service integration unit 420, and an authentication unit 430. The cloud computing service system 400 may further include at least one service providing unit. The cloud computing service system 400 may further include a first service providing unit 440 and a second service providing unit 450 as the at least one service providing unit.

The cloud computing service system 400 may be a security system for a cloud computing service.

The service integration unit 420, the authentication unit 430, and the at least one service providing unit may be constituent elements within the same physical apparatus. Alternatively, the service integration unit 420, the authentication unit 430, and the at least one service providing unit may be different physical apparatuses. That is, the cloud computing service system 400 may include a plurality of servers. For example, the service integration unit 420 may be a cloud service integration server. The authentication unit 430 may be an authentication server. The at least one service providing unit may be at least one cloud server.

The terminal 410 may provide a user on-demand service through a program such as a web browser, regardless of a type of the terminal 410.

The terminal 410 may request an authentication on the user using a token of a user that is generated using a multi-factor. The authentication on the user may be an authentication for the user to use the cloud service. The multi-factor may include at least one of an ID, a password, X 509 authentication, and an email.

The terminal 410 may access the cloud service using an ID and a password.

The service integration unit 420 may provide an environment for providing various cloud services to the terminal 410 and the user of the terminal 410 over a personal virtual network. The various cloud services may be provided to the terminal 410 as a converged service. According to convergence of the various cloud services, expandability of the cloud service may be enhanced.

The service integration unit 420 may provide the authentication unit 430 with an ID of the terminal 410 that requests the access. The service integration unit 420 may receive, from the authentication unit 430, a notification on whether the terminal 410 is approved. Approval of the terminal 410 may be approval of the ID of the terminal 410.

The authentication unit 430 may be operated by a third operation entity, instead of being operated by operation entities of the service integration unit 420 and at least one service providing unit. The authentication unit 430 may be operated by a certified operation entity.

The authentication unit 430 may manage information of the user that is provided from the terminal 410. The terminal 410 may provide personal information of the user to the authentication unit 430. The authentication unit 430 may be authorized to manage personal information of the user through the terminal 410 of the user. The authentication unit 430 may manage personal information of the user that is provided from the terminal 410.

The authentication unit 430 may be entrusted with the authentication on the user from a site joined by the user or a site desired to be joined by the user. Accordingly, the authentication unit 430 may perform the authentication on the user. The site joined by the user may be the service integration unit 420 or at least one service providing unit.

The terminal 410 may request the service integration unit 420 for an access to a cloud service. Through redirection of the service integration unit 420, the authentication unit 430 may perform the authentication on the user.

The authentication unit 430 may perform the authentication on the user that is requested from another institution.

The authentication unit 430 may perform the authentication only on a user who has joined in advance through a government institution or a public certificate institution. The authentication unit 430 may issue a temporary ID to the user who has joined in advance. Through issuance of the temporary ID, the authentication unit 430 may perform the authentication on the user without exposing personal information of the user.

At least one service providing unit may provide a cloud service to the terminal 410 authenticated by the authentication unit 430 over the virtual network.

Each of the at least service one providing unit may verify an access right of the user or the terminal 410 to the cloud service and may provide the cloud service corresponding to the access right.

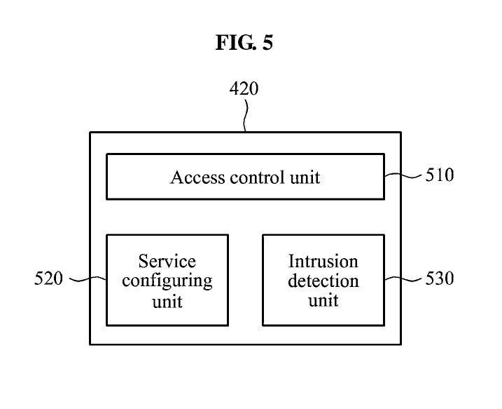

FIG. 5 is a block diagram illustrating a configuration of a service integration unit according to an embodiment.

The service integration unit 420 may include an access control unit 510, a service configuring unit 520, and an intrusion detection unit 530.

The functions of the service integration unit 420 described above with reference to FIG. 4 may be distributed to the access control unit 510, the service configuring 520, and the intrusion detection unit 530 and thereby be performed.

The access control unit 510 may grant an access authentication and a use right to a token of the terminal 410 based on a service policy of a service providing unit. The service providing unit may be one of the at least one service providing unit described above with reference to FIG. 4.

When a user requests an access to a cloud service, a request for accessing the service providing unit may be controlled by the access control unit 510.

The access control unit 510 may receive, from the terminal 410 of the user, a request for accessing the cloud service.

The access control unit 510 may transmit an ID of the terminal 410 to the authentication unit 430. The access control unit 510 may receive, from the authentication unit 430, a result of authenticating the user based on the ID.

The access control unit 510 may request the service providing unit, providing the cloud service, to verity an access right of the user to the cloud service.

The access control unit 510 may receive, from the service providing unit, the result of verifying the access right of the user to the cloud service. When the received result indicates that the user has the access right to the cloud service, the access control unit 510 may grant the access right to the cloud service to a token of the user.

The access control unit 510 may transmit, to the terminal 410, the token granted with the access right to the cloud service.

The access control unit 510 may receive, from the service providing unit, a request for registration information of the cloud service and right information of the user. The access control unit 510 may transmit the registration information and the right information to the service providing unit.

The service configuring unit 520 may generate a configuration for providing the cloud service on the service providing unit. The configuration for providing the cloud service may be a virtual machine that is performed on the service providing unit. The service configuring unit 520 may configure, on the service providing unit, all of the services that are associated with the cloud service requested by the user.

The service configuring unit 520 may perform functions such as a service gateway, a service broker, virtual private network management, privacy management and auditing, and the like.

The intrusion detection unit 530 may detect in advance and block a physical attack against the cloud computing service system 400 or the service integration unit 420. The intrusion detection unit 530 may improve availability of the cloud computing service system 400 or the service integration unit 420 through pre-detection and blockage. For example, the physical attack may be a network attack using traffic congestion outside or inside the cloud computing service system 400.

The intrusion detection unit 530 may install an elementary detector within the service providing unit. The elementary detector may be installed in a virtual machine on the service providing unit. The elementary detector is an essential program that operates on the virtual machine and may be installed when the virtual machine is generated.

The elementary detector may measure a network use rate and a resource use rate. The intrusion detection unit 530 may determine whether an intrusion into the cloud computing service system 400 or the service integration unit 420 has occurred based on the network use rate and the resource use rate measured by the elementary detector. When the intrusion is determined to have occurred, the intrusion detection unit 530 may notify the service integration unit 420 about the occurrence of the intrusion.

The elementary detector may collect information of all of the virtual machines within the cloud computing service system 400 and thereby decrease a probability of erroneously determining the occurrence of the intrusion and may decrease an occurrence probability of a false positive.

Depending on cases, the intrusion detection unit 530 may be present within the service providing unit and may be present within the authentication unit 430. That is, the intrusion detection unit 530 may not be subordinate to the service integration unit 420.

The intrusion detection unit 530 may collect network information and resource use information from a point in time when a virtual machine is generated within the service providing unit in order to provide a cloud service to the terminal 410. The elementary detector may collect information of all of the virtual machines that constitute cooperative clouding computing. The intrusion detection unit 530 may determine whether an intrusion has occurred and whether an attack has occurred by detecting an abnormal behavioral pattern and the like based on the collected information.

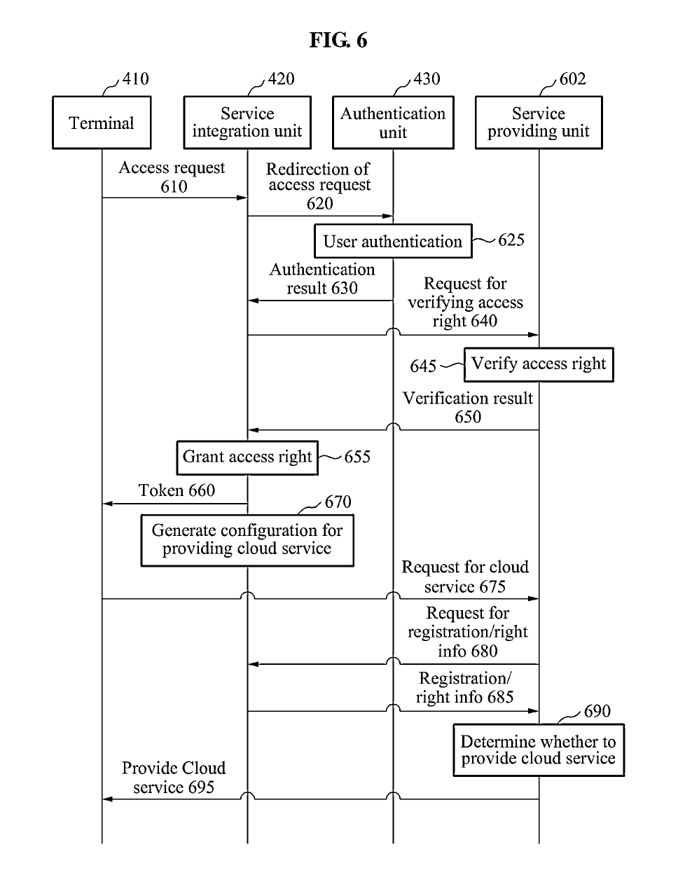

FIG. 6 is a flowchart illustrating a cloud service method according to an embodiment.

In operation 610, the terminal 410 of the user may transmit a request for accessing a cloud service to the service integration unit 420. The service integration unit 420 may receive, from the terminal 410, the request for accessing the cloud service. The request for accessing the cloud service may include an ID of the terminal 410.

The request for accessing the cloud service may be performed using a token. The terminal 410 may transmit, to the service integration unit 420, the token that is generated using a multi-factor. The token may indicate the request for accessing the cloud service.

The request for accessing the cloud service may be joining the cloud service as a member. The request for accessing the cloud service may include information of the user of the terminal 410. Information of the user of the terminal 410 may include at least one of personal information of the user, an ID of the user, and a password of the user. For example, personal information of the user, the ID of the user, and the password of the user may be provided to the service integration unit 420.

In operation 620, the service integration unit 420 may transmit the ID of the terminal 410 and information of the user to the authentication unit 430. In operation 620, the request for accessing the cloud service may be redirected from the service integration unit 420 to the authentication unit 430. Through the above redirection, the authentication unit 430 may perform an authentication on the user of the terminal 410.

In operation 625, the authentication unit 430 may perform the authentication on the user of the terminal 410 based on the ID of the terminal 410.

When the request for accessing the cloud service is joining the cloud service as a member, the authentication unit 430 may perform the authentication on the user and then generate an ID desired by the user. The authentication unit 430 may issue the ID desired by the user to the terminal 410. The authentication unit 430 may transmit the issued ID to the terminal 410. Alternatively, the authentication unit 430 may transmit the issued ID to the service integration unit 420 and the service integration unit 420 may transmit the issued ID to the terminal 410. The above joining as a member may be performed using various types of authentication means such as an open ID, an ID, a password, and an email.

The authentication unit 430 may store information of the user. The authentication unit 430 may encrypt and thereby store information of the user.

In operation 630, the authentication unit 430 may transmit, to the service integration unit 420, a result of authenticating the user based on the ID of the terminal 410. The service integration unit 420 may receive, from the authentication unit 430, the result of authenticating the user based on the ID of the terminal 410.

When the result of authenticating the user indicates that the user has an access right to the cloud service, the following operation 640 through operation 695 may be performed.

In operation 640, the service integration unit 420 may request a service providing unit 602, providing the cloud service, to verity the access right of the user to the cloud service. The service providing unit 602 may correspond to the first service providing unit 440 or the second service providing unit 450 of FIG. 4. The service providing unit 602 may receive, from the service integration unit 420, the request for verifying the access right of the user to the cloud service.

In operation 645, the service providing unit 602 may verify the access right of the user to the cloud service.

In operation 650, the service providing unit 602 may transmit, to the service integration unit 420, a result of verifying the access right of the user to the cloud service. The service integration unit 420 may receive, from the service providing unit 602, the result of verifying the access right.

When the result of verifying the access right indicates that the user has the access right to the cloud service, the service integration unit 420 may grant the access right to the cloud service to the token of the user in operation 655.

The service integration unit 420 may grant the access right to the token of the user based on a policy of the cloud service of the service providing unit 602.

A plurality of cloud services may be provided. Also, the plurality of cloud services may be provided from the plurality of service providing units 602, respectively. When the user or the terminal 410 of the user simultaneously uses the plurality of cloud services, the service integration unit 420 may grant access rights to the respective plurality of cloud services.

In operation 660, the service integration unit 420 may transmit, to the terminal 410, the token granted with the access right. The terminal 410 may receive, from the service integration unit 420, the token granted with the access right.

Through following operation 670 to operation 695, the cloud service may be provided to the terminal 410. The service providing unit 602 may provide the cloud service to the terminal 410 over a virtual network.

In operation 670, the service integration unit 420 may generate a configuration for providing the cloud service on the service providing unit 602.

The configuration for providing the cloud service may be a virtual machine that is performed on the service providing unit 602. The service integration unit 402 may generate the virtual machine of providing the cloud service to the terminal 410 on the service providing unit 602.

In operation 675, the terminal 410 may request the service providing unit 602 for the cloud service. The terminal 410 may request the service providing unit 602 for the cloud service using the token granted with the access right. For the above cloud service request, the terminal 410 may transmit, to the service providing unit 602, the token granted with the access right.

In operation 680, the service providing unit 602 may transmit, to the service integration unit 420, a request for registration information of the cloud service and right information of the user of the terminal 410. The service integration unit 420 may receive, from the service providing unit 602, the request for registration information of the cloud service and right information of the user of the terminal 410.

In operation 685, the service integration unit 420 may transmit the registration information and the right information to the service providing unit 602. The service providing unit 602 may receive the registration information and the right information from the service integration unit 420.

In operation 690, the service providing unit 602 may determine whether to provide the cloud service to the terminal 410 based on the received registration information and right information. When the right information indicates that the user has the right to use the cloud service, the service providing unit 602 may determine to provide the cloud service to the terminal 410. The service providing unit 602 may determine whether the right information indicates that the user has the right to use the cloud service, based on registration information of the cloud service.

In operation 695, when it is determined that the right information indicates that the user has the right to use the cloud service, the service providing unit 602 may provide the cloud service to the terminal 410.

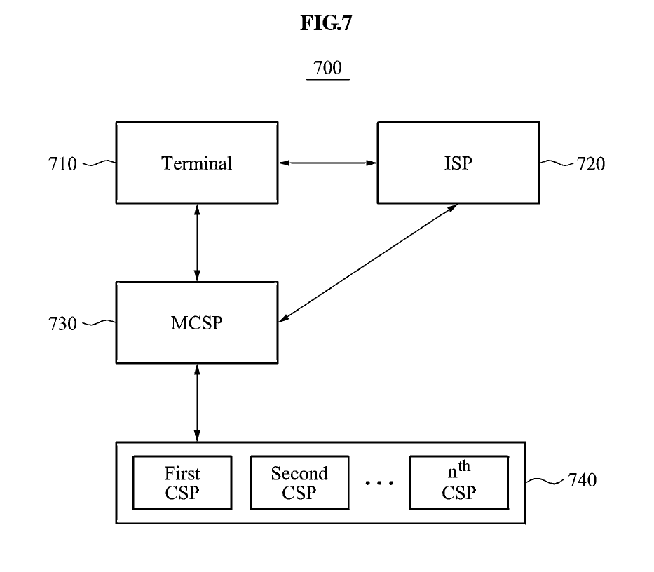

FIG. 7 is a block diagram illustrating a cloud computing service system according to an embodiment.

A cloud computing service system 700 may include a terminal 710, an identification service provider (ISP) 720, a market-based cloud service portal (MCSP) 730, and a cloud service provider (CSP) 740. In addition to the aforementioned configuration, other constituent elements of the cloud computing service system 400 described above with reference to FIG. 4 may be included in the cloud computing service system 700.

A plurality of CSPs 740 may be provided. In FIG. 7, the plurality of CSP includes a first CSP through an n^{th} CSP.

The terminal 710 may correspond to the terminal 410 of FIG. 4. The ISP 720 may correspond to the authentication unit 430 of FIG. 4. The MCSP 730 may correspond to the service integration unit 420 of FIG. 4. The CSP 740 may correspond to at least one service providing unit of FIG. 4.

The terminal 710 of the user may entrust a third certified ISP 720 with information of the user. The terminal 710 may provide a user on-demand service through a program such as a web browser, regardless of a type of the terminal 710.

The ISP 720 may be operated by a third certified service provider or a public institution. The ISP 720 may be entrusted with information of the user. The ISP 720 may manage the entrusted information of the user. The user of the terminal 710 may join the ISP 720 using various authentication means such as a certificate or an open ID. The ISP 720 may receive an entrust request of authentication from a site desired to be joined by the user. The ISP 720 may notify the site about a result of authenticating the user.

The ISP 720 may encrypt information of the joined user using a private key of the user. The ISP 720 may manage the encrypted information of the user. In response to the request of the terminal 710, the ISP 720 may provide an auditing function with respect to integrity and confidentialness of information of the user.

The ISP 720 may manage a pseudo ID (PID) with respect to each of a user on-demand service and various Internet-based services. For the above management, when the user requests a predetermined service, the ISP 720 may generate a PID for using the requested service. The ISP 720 may have the right to distribute a public key of the user in accordance with pre-agreement with the joined user.

The ISP 720 may generate a PID for a service when the user joins the service in response to a request of the user. For example, the PID may be generated for each individual service. Also, when the terminal 710 purchases a service of a predetermined CSP using the MCSP 730, the ISP 720 may provide an authentication on the user to the CSP on behalf of the terminal 710. Also, the ISP 720 may join the service in order to be provided with the service from the CSP.

The MCSP 730 may function as a broker of a multi-cooperative cloud service. The MCSP 730 is a type of a service selling broker and may do selling for the CSP 740. The MCSP 730 may provide a configuration, management, and user environment with respect to the service of the CSP 740 that is purchased by the terminal 710. For the above providing, contract and mutual authentication between the MCSP 730 and the CSP 740 may be required.

When the terminal 710 requests the MCSP 730 to purchase the cloud service, the MCSP 730 may provide the terminal 710 with a user interface (UI) in a web or an application form. For example, based on the type of the cloud service provided from the CSP 740, the MCSP 730 may provide a UI or URL redirection. The user of the terminal 710 may use the cloud service through the UI or URL redirection.

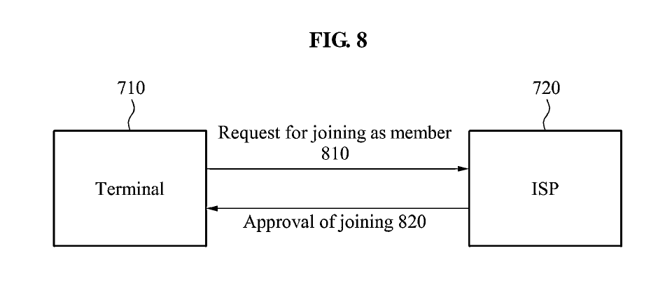

FIG. 8 is a diagram illustrating a procedure in which a user joins an ISP as a member according to an embodiment.

In operation 810, the terminal 710 may transmit information of the user, an ID, and a password to the ISP 720 in order to join the ISP 720 as a member. The ID may be an ID desired to be issued by the user.

In operation 820, the ISP 720 may perform an authentication on the user who requests joining the ISP 720 as a member. After authenticating the user, the ISP 720 may issue the ID desired by the user.

The ISP 720 may encrypt and thereby store information of the user. Also, the ISP 720 may perform an authentication process on the user that is requested from another institution.

The ISP 720 may transmit, to the terminal 710, information indicating approval of joining

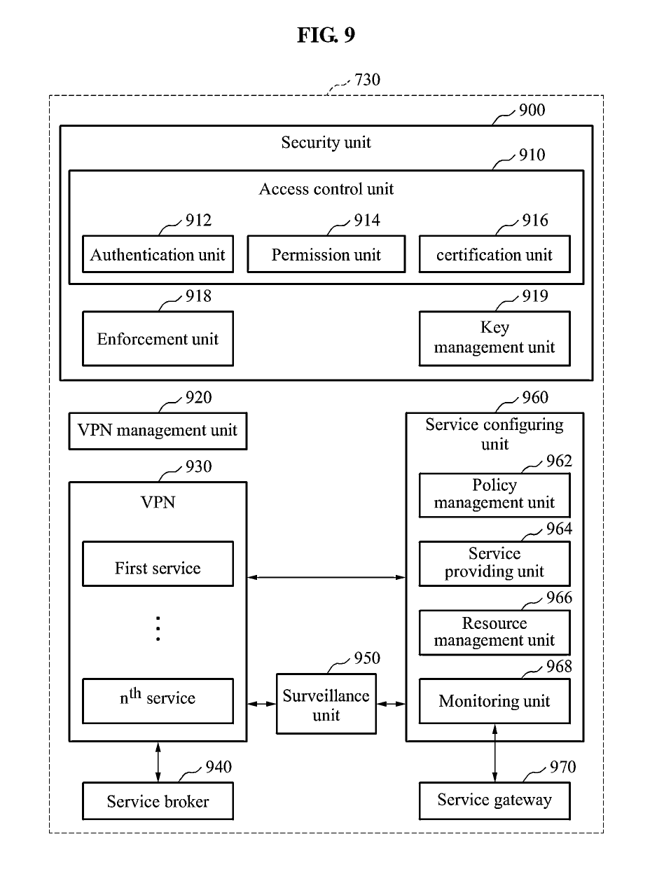

FIG. 9 is a diagram illustrating a configuration of a MCSP according to an embodiment.

The MCSP 730 may include a security unit 900, a virtual private network (VPN) management unit 920, a VPN 930, a service broker 940, a surveillance unit 950, a service configuring unit 960, and a service gateway 970.

The security unit 900 may include an access control unit 910, an enforcement unit 918, and a key management unit 919. The access control unit 910 may include an authentication unit 912, a permission unit 914, and a certification unit 916.

The VPN 930 may provide a plurality of services. Each of the plurality of services may be a cloud service. In FIG. 9, the plurality of services includes a first service to an n^{th} service.

The service configuring unit 960 may include a policy management unit 962, a service providing unit 964, a resource management unit 966, and a monitoring unit 968.

When the terminal 710 logs in the CSP 740, the terminal 710 may transmit, to the authentication unit 912, an address and an ID of the ISP 720 that may perform an entrusted authentication on behalf the terminal 710. The authentication unit 912 may request the ISP 720 to authenticate the user of the terminal 710. In the above redirection, the authentication unit 912 may transmit the ID of the terminal 710 to the ISP 720. The ISP 720 may perform the entrusted authentication based on an input of the user. After the above authentication, the ISP 720 may transmit, to the MCSP 730, the ID that is encrypted using a private key of the user. Also, the ISP 720 may encrypt a public key that includes user information, and may transmit the encrypted public key to the MCSP 730.

The permission unit 914 may verify the right of the user to the service based on the ID and information of the user, and may verify details about an on-demand service purchased by the user. The permission unit 914 may prepare a personal service profile (PSP) using an XML. The permission unit 914 may request the service configuring unit 960 for a service configuration using the PSP.

The certification unit 916 may decrypt the ID and information of the user using the transferred public key. The certification unit 916 may verify an identity of the user based on the decryption result.

The enforcement unit 918 may be in charge of a security policy of the MCSP 730.

The key management unit 919 may provide and manage a key suitable for the service or the terminal 710 that desires to use the service.

The VPN 930 may configure a personal network for providing the service to the terminal 710. Services that are provided to the terminal 710 may be allocated to the respective VPNs, and may be provided to the terminal 710 through the above allocation.

The VPN management unit 920 may generate and manage a personal network for a VPN.

The service broker 940 may manage a VPN session for various user services. The service broker 940 may generate a session for each service through the VPN management unit 920. When the service is terminated, the service broker 940 may delete the VPN 930 and user data associated with the VPN 930 through the VPN management unit 920. The user data may include information of the user and cache data of the service. The service broker 940 may terminate a service that is not used during a predetermined period of time, through the VPN management unit 920. That is, the service broker 940 may control the overall function of the MCSP 730 associated with a service.

The surveillance unit 950 may monitor whether the terminal 710 uses the service rightly. The surveillance unit 950 may monitor abnormal traffic and intrusion into a right. The surveillance unit 950 may monitor the overall security service of the MCSP 730.

The service gateway 970 may provide secure communication between the MCSP 730 and the CSP 740. The service gateway 970 enables each of the plurality of CSPs 740 to communicate with the VPN 930 over a secure communication network. For secure communication, the service gateway 970 may configure a secure communication session with each of the plurality of CSPs 740. The service gateway 970 may control the configured communication session.

The service configuring unit 960 may be provided with a PSP from the access control unit 910. The service configuring unit 960 may configure a service based on the PSP. When communicating with the CSP 740 in order to use the service, the service configuring unit 960 may use an open API that is provided from the CSP 740.

The resource management unit 966 may manage a service resource provided from the CSP 740 for a configuration of the service. The resource management unit 966 may manage information about a resource specified based on the PSP. Information about the resource may include a service URL, storage, a central processing unit (CPU), and the like.

The resource management unit 966 may request the CSPs 740 specified within the PSP for a service profile (SP) for a service of each CSP 740. The resource management unit 966 may provide the CSPs 740 specified within the PSP with information required for sharing a service resource and cooperation between the CSPs 740. For example, the terminal 710 may use an application service of company A. The terminal 710 may store, in a storage service of the company A, data that is generated as according to use of an application service. Here, when an access from a service of the company A to storage of company B occurs, an application of the company A may obtain, from the resource management unit 966, information required to access the storage of the company B. Information required to access the storage may include an URP, an IP address, an ID of a user, and the like. The application of the company A may access the storage of the company B using the obtained information.

The resource management unit 966 collects current use state information of a resource and the like from each CSP and thereby updates and manages the same, and provides the collected information as a constituent element required.

The service providing unit 964 may request the VPN management unit 920 to generate a service session in order to provide a service. The service providing unit 964 may configure an environment for providing a service.

The policy management unit 962 may manage a security policy for each service or each user.

The monitoring unit 968 may monitor a service error and may continuously perform service monitoring for providing an accurate service.

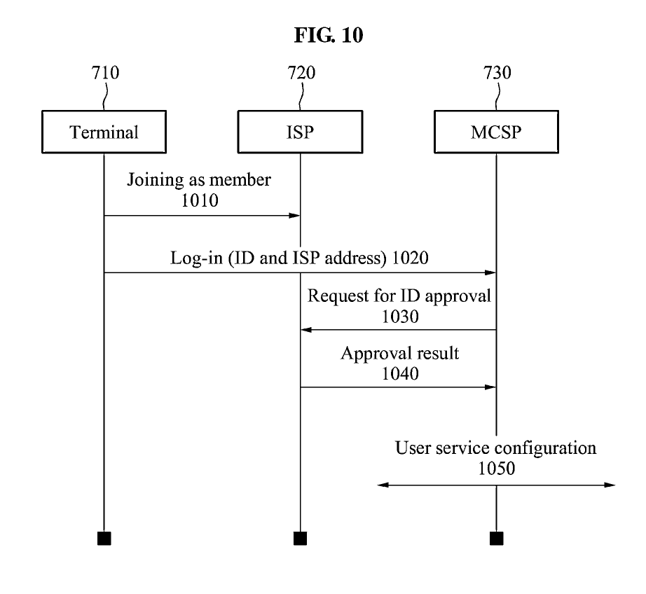

FIG. 10 is a flowchart illustrating a personal information delegation and log-in procedure of a user according to an embodiment.

Hereinafter, a process in which the terminal 710 entrusts the ISP 720 with personal information of a user and a process in which the terminal 710 logs in the MCSP 730 will be described.

In operation 1010, the terminal 710 may request the ISP 720 for joining as a member. The terminal 710 may request the ISP 720 for joining as a member and delegation of personal information.

In operation 1020, the terminal 710 may log in the MCSP 730. The terminal 710 may log in the MCSP 730 through a web browser. The terminal 710 may log in the MCSP 730 using an ID of the user and an address of the ISP 720. Through the log-in, the ID of the user and the address of the ISP 720 may be transmitted to the MCSP 730.

In operation 1030, the MCSP 730 may request the ISP 720 for approving the ID. Approval of the ID may indicate that providing a service to the terminal 710 indicated by the ID is approved. The MCSP 730 may request the ISP 720 for approving the ID using the address of the ISP 720. Together with the request, the MCSP 730 may transmit, to the ISP 720, an address of the MCSP 730 that is to receive the approval result.

In operation 1040, the ISP 720 may notify the MCSP 730 about a result of approving the ID. The ISP 720 may transmit the result of approving the ID to the address of the MCSP 730 that is provided to the ISP 720.

In operation 1050, the MCSP 730 provided with the approval result may configure a service for the user. With respect to each of services provided from the ISP 720, the MCSP 730 may configure a service using a PID to be used for each service.

As described above with reference to FIG. 9, the above log-in process may be performed by the access control unit 910 of the MCSP 730.

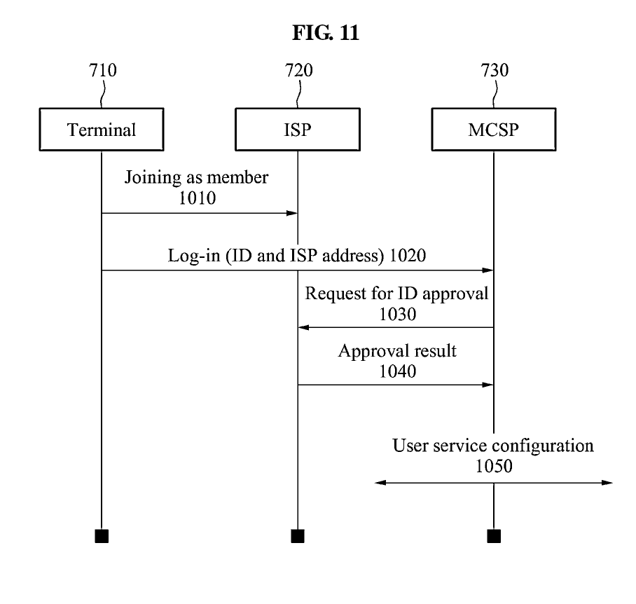

FIG. 11 is a flowchart illustrating a process of configuring a user service according to an embodiment.

In operation 1110, the service configuring unit 960 may be provided with a PSP of a user from the access control unit 910. The service configuring unit 960 may configure a service for the user based on the PSP of the user.

In operation 1120, the service configuring unit 960 may transfer the PSP to the resource management unit 966.

In operation 1130, the resource management unit 966 may generate a communication session with the service gateway 970.

The resource management unit 966 may request the service gateway 970 for the service that is provided from the service configuring unit 960.

In operation 1140, the service gateway 970 may request the CSP 740, providing the service, for the service. The service gateway 970 may communicate with the CSP 740 using an open API that is provided from the CSP 740.

In operation 1150, the CSP 740 may provide, to the service configuring unit 960, the service requested by the gateway.

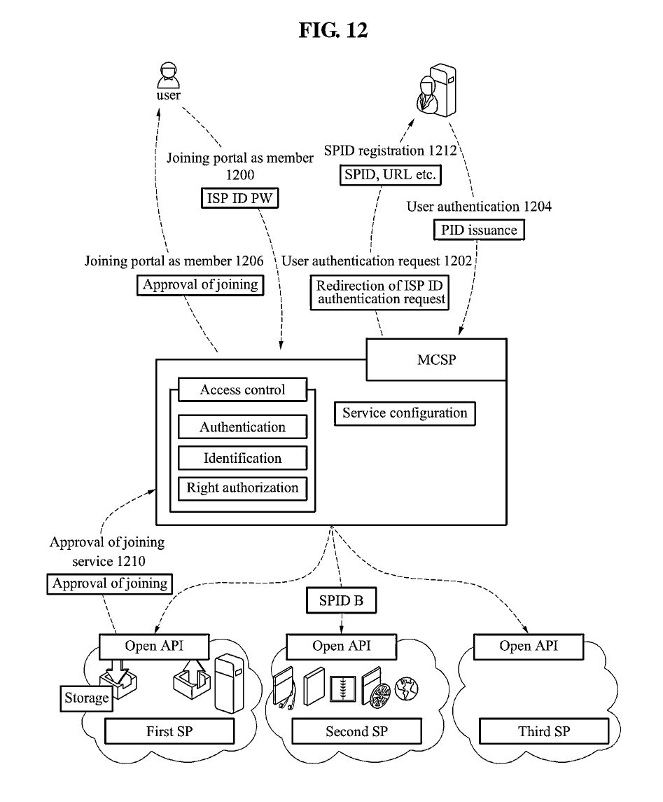

FIG. 12 is a diagram illustrating a procedure of becoming a member of a MCSP and using the MCSP according to an embodiment.

In operation 1200, a user may request the MCSP 730 for joining as a member through the terminal 710. To be provided with a service of the CSP 740, the terminal 710 may purchase a service after joining the MCSP 730 as a member. An authentication on the user may be performed among the terminal 710, the ISP 720, and the MCSP 730.

In operation 1202, the MCSP 730 may request the ISP 720 for authenticating the user. The MCSP 730 may redirect, to the selected ISP 720, information of an ID and a password input when the user logs in the MCSP 730. Since redirection is used, information about the ID and the password may not remain within the MCSP 730.

In operation 1204, the ISP 720 may perform the authentication on the user and then issue a PID for joining the MCSP 730 as a member. The ISP 720 may transfer the PID and MCSP request information only to the MCSP 730. The PID and MCSP request information may be encrypted. The MCSP request information may be information about an interest and preference of the user associated with the service. The ISP 720 may store, as USP in an XML form, the PDI and service request information to be used in the MCSP 730 that is joined by the user as a member. The USP may be encrypted and thereby be stored.

In operation 1206, the MCSP 730 may generate the PSP in the XML form using the USP that is transferred from the ISP 720. The MCSP 730 may transfer the authentication result to the terminal 710, and may approve the user's joining as a member.

In operation 1208, the terminal 710 may purchase a desired service of the CSP 740 through the MCSP 730. For the above purchase, the MCSP 730 may generate a service PID (SPID) that is used for using a service, and may request the CSP 740 to join the service using the generated SPID.

In operation 1210, the CSP 740 may approve the joining requested by the MCSP 730. The terminal 710 may purchase a desired service of the CSP 740 through the MCSP 730. For example, the MCSP 730 may purchase and manage a desired service of the CSP 740 using the SPID.

In operation 1212, the MCSP 730 may update the PSP. The MCSP 730 may transfer, to the ISP 720, information of the service purchased by the terminal 710. Information of a service may include the SPID. For a service of the CSP 740, the MCSP 730 may generate and manage an SPID for each service. The MCSP 730 may delete the PSP and relevant data at a point in time when the service is terminated.

When the terminal 710 requests a predetermined service of the CSP 740, the MCSP 730 may verify whether the requested service is purchased. When the service requested by the terminal 710 is not purchased, the MCSP 730 may generate a new SPID and may perform the aforementioned purchase procedure using the generated SPID.

The CSP 740 may provide the service requested by the terminal 710. The MCSP 730 may update a PSP that is modified service information.

When the terminal 710 requests the MCSP 730 for log-out, the MCSP 730 may transmit, to the ISP 720, a PSP that is finally updated at a point in time when providing of the service is suspended. The MCSP 730 may delete the PID and data that are used while providing the service, and may perform log-out. The ISP 720 may update the USP using the PSP transmitted from the MCSP 730, and may store the updated USP.

As described above, a different ID may be used for each layer depending on embodiments. For example, an ISP ID may be used between the terminal 710 and the ISP 720, and a PID may be used between the ISP 720 and the MCSP 730. That is, in each operation, different IDs may be issued and be used.

Information encrypted using a first encryption algorithm may be transmitted and received between the terminal 710 and the ISP 720. Information encrypted using a second encryption algorithm may be transmitted and received between the ISP 720 and the MCSP 730. Information encrypted using a third encryption algorithm may be transmitted and received between the MCSP 730 and the CSP 740.

As described above, a different ID may be issued for each operation or a different encryption algorithm may be used in order to protect personal information. Accordingly, even though an ID of a user is exposed by a hacking and the like, personal information of the user and data that is being used by the user may be protected.

A cloud computing system may form a plurality of reliable security sections by setting the first encryption algorithm used between the terminal 710 and the ISP 720, the second encryption algorithm used between the ISP 720 and the MCSP 730, and the third encryption algorithm used between the MCSP 730 and the CSP 740 to be different from each other. Information of a user may be effectively protected through the plurality of reliable security sections.

Since the MCSP 730 controls user information transfer and resource access between the plurality of CSPs 740, the cloud computing system may protect user information in terms of user information transfer and processing between the plurality of CSPs 740.

The cloud computing system may effectively protect user information by setting a first user identifier used between the terminal 710 and the ISP 720, a second user identifier used between the ISP 720 and the MCSP 730, and a third user identifier used between the MCSP 730 and the CSP 740 to be different from each other.

The embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A cloud service method, comprising:
receiving a request for accessing a cloud service from a terminal of a user;
requesting a service providing unit, providing the cloud service, to verify an access right of the user to the cloud service;
receiving a result of verification from the service providing unit; and
granting a token of the user with the access right to the cloud service when the result of verification indicates that the user has the access right to the cloud service.

2. The method of claim 1, further comprising:
transmitting an identifier of the terminal to an authentication unit; and
receiving, from the authentication unit, a result of authenticating the user based on the identifier.

3. The method of claim 1, further comprising:
transmitting a token of the user to the terminal.

4. The method of claim 1, further comprising:
receiving, from the service providing unit, a request for registration information of the service cloud and right information of the user; and
transmitting the registration information and the right information to the service providing unit.

5. The method of claim 1, further comprising:
generating a configuration for providing the cloud service on the service providing unit.

6. The method of claim 5, wherein the configuration for providing the cloud service is a virtual machine that is performed on the service providing unit.

7. The method of claim 1, wherein the cloud service is provided to the terminal by the service providing unit over a virtual network.

8. The method of claim 1, wherein the cloud service is configured to be plural.

9. The method of claim 1, wherein the access right is granted to the token based on a policy of the service providing unit with respect to the cloud service.

10. A non-transitory computer-readable recording medium storing a program to implement the method of claim 1.

11. A cloud service integration server, comprising:
an access control unit to receive a request for accessing a cloud service from a terminal of a user, to request a service providing unit, providing the cloud service, to verify an access right of the user to the cloud service, to receive a result of verification from the service providing unit, and to grant a token of the user with the access right to the cloud service when the result of verification indicates that the user has the access right to the cloud service; and
a service configuring unit to generate a configuration for providing the cloud service on the service providing unit.

12. The cloud service integration server of claim 11, wherein the access control unit transmits an identifier of the terminal to an authentication unit, and receives, from the authentication unit, a result of authenticating the user based on the identifier.

13. The cloud service integration server of claim 11, wherein the access control unit transmits a token of the user to the terminal.

14. The cloud service integration server of claim 11, wherein the access control unit receives, from the service providing unit, a request for registration information of the service cloud and right information of the user, and transmits the registration information and the right information to the service providing unit.

15. The cloud service integration server of claim 11, wherein the configuration for providing the cloud service is a virtual machine that is performed on the service providing unit.

16. The cloud service integration server of claim 11, wherein the cloud service is provided to the terminal by the service providing unit over a virtual network.

17. The cloud service integration server of claim 11, wherein the cloud service is configured to be plural.

18. The cloud service integration server of claim 11, wherein the access right is granted to the token based on a policy of the service providing unit with respect to the cloud service.
